(19) United States
(12) Patent Application Publication
(10) Pub. No.: US 2020/0410411 A1
(43) Pub. Date: Dec. 31, 2020

(54) Auditing Compliance with an Optimized Travel Route for Product Procurement

(71) Applicant: Wells Fargo Bank, N.A., San Francisco, CA (US)

(72) Inventor: Rory A. Ward, Troy, ID (US)

(21) Appl. No.: 15/041,632

(22) Filed: Feb. 11, 2016

(51) Int. Cl. G06Q 10/04; G01C 21/34; G06Q 30/06

(52) U.S. Cl. CPC G06Q 10/047; G06Q 30/0613; G01C 21/343

(57) ABSTRACT

A method for auditing implementation of a travel route for procuring items includes receiving a list of items to be procured. An optimized travel route is created for procuring the items. The optimized travel route is sent to a mobile electronic computing device. Information is received from the mobile electronic computing device regarding purchases made for the items. The information received is used to determine compliance with the optimized travel route. When a determination of non-compliance with the optimized travel route is made, information indicating non-compliance with the optimized travel route is sent to the mobile electronic computing device for display on a display screen of the mobile electronic computing device.

### BACKGROUND

Organizations commonly have a need to procure office supplies and other products, such as furniture and equipment, needed for the organization. When the supplies and other products are available locally, some organizations use delivery services to purchase and pick up these items. Many organizations use internal employees to purchase and pick up the items.

The office supplies and other products can be located at diverse locations in a geographical area. Vehicles such as automobiles, vans and trucks can be used to pick up these items. When drivers of the vehicles determine travel routes to pick up the items, the drivers can take routes that are not cost efficient.

### SUMMARY

Embodiments of the disclosure are directed to a method implemented on an electronic computing device for auditing implementation of a travel route for procuring items, the method comprising: on the electronic computing device, receiving a list of items to be procured; creating an optimized travel route for procuring the items; sending the optimized travel route to a mobile electronic computing device; receiving information from the mobile electronic computing device regarding purchases made for the items; using the information received to determine compliance with the optimized travel route; and when a determination of non-compliance with the optimized travel route is made, sending information indicating non-compliance with the optimized travel route to the mobile electronic computing device for display on a display screen of the mobile electronic computing device.

In another aspect, an electronic computing device comprising: a processing unit; and system memory, the system memory including instructions which, when executed by the processing unit, cause the electronic computing device to: receive an optimized travel route from a server computer; render a digital dashboard on the electronic computing device, the digital dashboard displaying the optimized travel route, the optimized travel route displaying a travel route to one or more retail locations at which one or more products specified on the optimized travel route can be purchased; send to the server computer a location of the electronic computing device; receive from the server computer information regarding compliance with implementing the optimized travel route; determine whether the information indicates non-compliance with the optimized travel route; and when a determination is made of non-compliance with the optimized travel route, update a display on the digital dashboard to indicate non-compliance.

In yet another aspect, an electronic computing device includes a processing unit; and system memory, the system memory including instructions which, when executed by the processing unit, cause the electronic computing device to: receive a list of items to be procured; create an optimized travel route for procuring the items, the optimized travel route including first identifiers for retail stores for procuring each of the items on the list of items and also including first locations of the retail stores; send the optimized travel route to a mobile electronic computing device; receive information regarding purchases for one or more of the items, the information including second identifiers for retail stores at which the purchases for the one or more items were made and second locations of the retail stores at which the purchases were made; for each item purchased, compare at least one of the first identifiers with at least one of the second identifiers and compare at least one of the first locations with at least one of the second locations; and when the at least one of the first locations does not match the at least one of the second locations and when a retail store identified by the at least one of the first identifiers does not match a retail store identified by the at least one of the second identifiers: send a message to the mobile electronic computing device that a user of the mobile electronic computing device is not in compliance with the optimized travel route; create an updated travel route; send the updated travel route to the mobile electronic computing device; based on the information received regarding the purchases for the one or more of the items: determine whether each item purchased was purchased in a sequence indicated by the optimized travel route; and when a determination is made that an item to be procured was skipped in the optimized travel route, send a reminder to the user to purchase the item.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports auditing compliance with an optimized travel route for product procurement.

FIG. 2 shows example modules of the server computer of FIG. 1.

FIG. 3 shows an example digital dashboard.

FIG. 4 shows an example optimized travel route that can be displayed using the digital dashboard of FIG. 3.

FIG. 5 shows an example status display summary that can be displayed using the digital dashboard of FIG. 3.

FIG. 6 shows an example daily route report.

FIG. 7 shows an updated optimized travel route that is superimposed on the optimized travel route of FIG. 4.

FIG. 8 shows a flowchart of an example method for creating an optimized travel list for procuring business items.

FIG. 9 shows a flowchart of an example method for using a digital dashboard on the mobile electronic computing device of FIG. 1.

FIG. 10 shows example physical components of the server computer of FIG. 1.

### DETAILED DESCRIPTION

The present disclosure is directed to systems and methods that can optimize routes used by drivers to pick up products needed by an organization. The optimized travel routes can be displayed on a digital dashboard of a mobile electronics computing device, such as a smart phone, so a driver can visually see the routes. The digital dashboard can also be displayed on a client computer to permit the routes to be audited by employees of the organization.

In this disclosure, the organization is a business organization, referred to as a business herein. The products needed by the organization are referred to herein as business items. The business items can include office supplies, equipment, furniture and other items. The systems and methods can also apply to other types of organizations, such as government organizations and non-profit organizations.

The digital dashboard can display a location of each driver in real time, using global positioning system (GPS) software on the mobile electronics computing device. The business can monitor status of drivers based on the location and re-route drivers when necessary. In addition, the digital dashboard can display purchase prices for the business items at or near a time when purchases of the business items occur.

The business can also audit information obtained from the digital dashboard and mobile electronics computing device to determine whether the drivers correctly implement the routes, purchase and pick up the business items at recommended locations and do not overpay for the business items. A report can be printed of results of the audit, showing cost savings obtained by drivers who followed the optimized travel routes and any deviations from the optimized travel routes.

The systems and methods permit the business to improve operational efficiencies and reduce business costs. In addition, the systems and methods permit the business to monitor performances of drivers, help to correct efficiencies of drivers when needed, identify drivers who may need additional training and counsel drivers who are not performing.

In addition to reducing business costs by creating optimized travel routes, the business can also reduce costs by identifying vendors that can provide products and services at an optimized price for a product to be procured. The business can acquire product cost data on various business items and determine which vendors offer a best price for a product of similar quality. The business can also take advantage of volume discounts that may be offered to the business at these vendors. As a result, the optimized travel routes can be based on an optimized selection of vendors. In this disclosure, a vendor refers to a retail store in which a business item can be procured. In this disclosure, the terms vendor and retail store are used interchangeably.

In some implementations, the mobile electronics computing device, such as the smart phone, can include a mobile wallet feature. The mobile wallet feature can permit the smart phone to be used to purchase the business items. In addition to having the functionality to purchase the business items, the mobile wallet can store a purchase history and a geo location history. The business can upload and track the purchase history and the geo location history from the mobile wallet.

The systems and methods disclosed herein are directed to a computer technology that solves an existing problem in purchasing logistics and delivery employee performance. Instead of having separate computer systems and platforms for each of purchasing logistics and employee performance, the systems and methods permit improvements in purchasing logistics and the monitoring of employee performance through a single platform. The use of a single platform also improves business computer efficiencies through the use of the digital dashboard and ability to change routes automatically based on the digital dashboard.

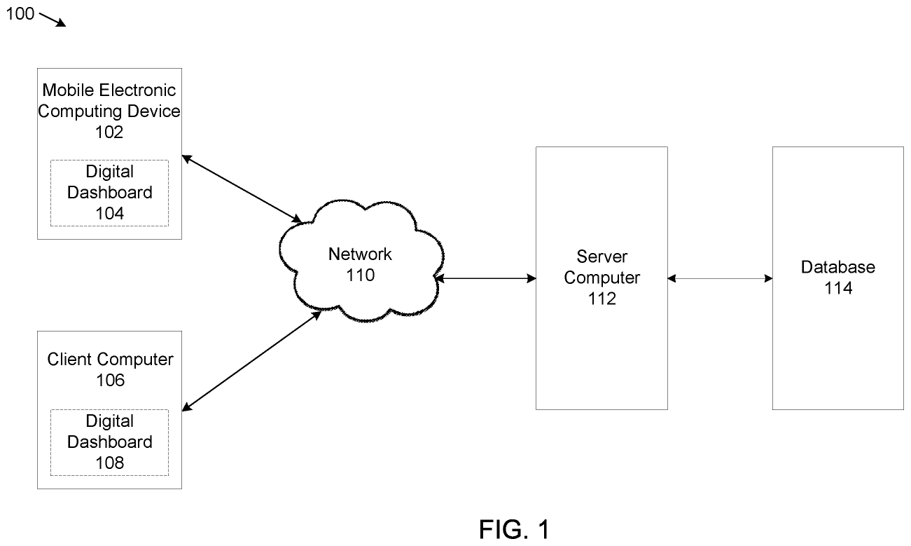

FIG. 1 shows an example system 100 that supports auditing compliance with an optimized travel route for product procurement. The example system 100 includes a mobile electronic computing device 102, a client computer 106, a network 110, a server computer 112 and a database 114. The mobile electronic computing device 102 includes a digital dashboard 104 and the client computer 106 includes a digital dashboard 108. In some implementations, digital dashboard 104 and digital dashboard 108 are the same. In other implementations, digital dashboard 104 and digital dashboard 108 can be different. More than one mobile electronic computing device and client computer can be used.

The example mobile electronic computing device 102 is a mobile device such as smart phone and tablet computer that can access server computer 112 via a wireless connection through network 110. The mobile electronic computing device 102 can include one or more software applications that can permit access to server computer 112. One of the software applications can be an application for a digital dashboard, such as digital dashboard 104. In this disclosure, the mobile electronic computing device 102 is a smart phone and the terms smart phone and mobile electronic computing device 102 are used interchangeably.

The example digital dashboard 104 is an electronic dashboard that can be displayed on a display screen of the smart phone. The digital dashboard 104 can display an optimized travel route for the user of the smart phone to take when procuring the business items. The digital dashboard 104 can also display status, such as products purchased and expenses occurred at locations on the optimized travel route. The digital dashboard 104 is described in more detail later herein.

The client computer 106 is a desktop computer or laptop computer of the business. The client computer 106 is connected to server computer 112 via network 110. The client computer 106 can include a plurality of software applications including an application for a digital dashboard, such as digital dashboard 108. Employees of the business can monitor activity of drivers on the optimized travel route using the digital dashboard 108. More than one client computer can be used.

The example digital dashboard 108 is an electronic dashboard that can be displayed on a display screen of client computer 106. The digital dashboard 108 can show optimized travel routes for a plurality of drivers. For each optimized travel route, the digital dashboard 108 can display status, such as business items purchased and expenses occurred on the optimized travel route. An employee of the business can remotely monitor driver activity using the digital dashboard 108 and implement a re-routing of a driver if necessary. In some implementations, digital dashboard 108 can have identical content of digital dashboard 104. In other implementations, digital dashboard 108 can have different content. For example, digital dashboard 108 can include functionality such as onscreen commands to send messages to a driver and to reroute the driver. In addition, a formatting of digital dashboard 108 on client computer 106 can be different from a formatting of digital dashboard 104 on mobile electronic computing device 102.

The example network 110 is a computer network that can permit communication between one or more of mobile electronic computing device 102, client computer 106 and server computer 112. Network 110 can include one or more of a corporate network and the Internet.

The example server computer 112 is a server computer of the business. Server computer 112 includes a software application for creating an optimized travel route for drivers based on identified locations for procuring business items at a best price. Server computer 112 can also receive status information from smart phones of drivers. The status information can include current GPS locations of the driver, stops made by the driver, purchases made by the driver, price of the purchases made by the driver and other information. Server computer 112 can update digital dashboards 104 and 108 based on the status information. More than one server computer can be used.

The example database 114 is an electronic database that can be accessed from server computer 112 or other server computers not shown in FIG. 1. Database 114 can store product information for the business and information regarding vendors that can be used to procure the products. Database 114 can also include profile information for employees of the business, including drivers used to procure products. Database 114 can also store purchasing history for products procured. Other information can be stored on database 114.

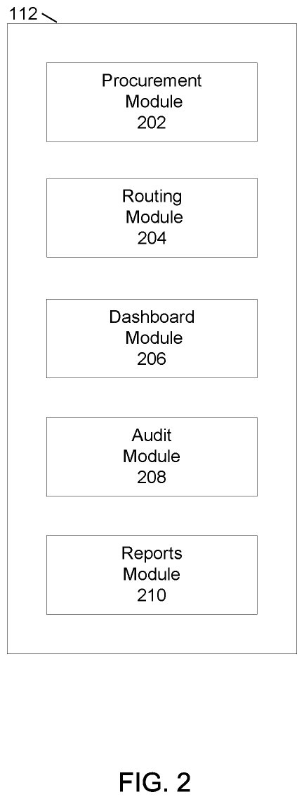

FIG. 2 shows example modules of server computer 112. The modules include a procurement module 202, routing module 204, a dashboard module 206, an audit module 208 and a reports module 210.

The example procurement module 202 identifies products to be procured by the business during a specific day, identifies local vendors at which the products can be procured at a good price and identifies drivers who are available to procure the products at the identified local vendors on the specific day. The products to be procured can be identified via input from one or more employees of the business. The local vendors at which the products can be procured can also be identified from one or more employees of the business. The identified local vendors are ones that can provide a good price for the product, ideally a best price, at an acceptable level of product quality. The drivers can be direct employees of the business, contractors hired by the business or a combination of direct employees and contractors.

The example routing module 204 receives identification for the products to be procured, receives identification for local vendors and drivers from the procurement module 202, assigns drivers to obtain the identified products to be procured and determines optimized travel routes for each driver to procure the identified products at locations of the local vendors. The routing module 204 attempts to determine the optimized travel routes such that total driving time for each driver to obtain the products is minimized. More detailed information regarding routes is provided later herein.

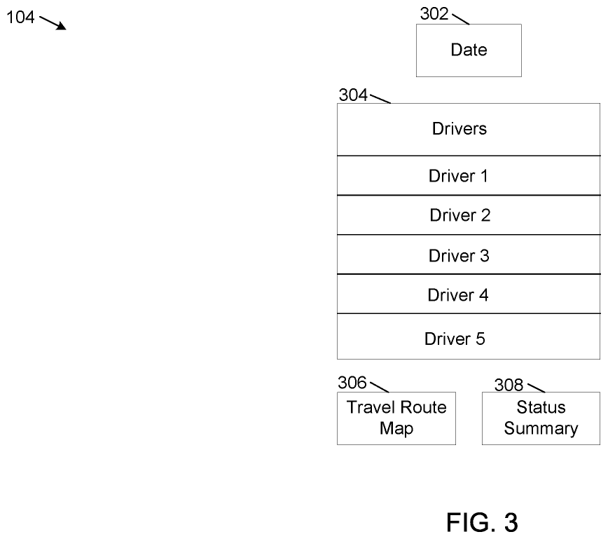

The example dashboard module 206 renders a digital dashboard on mobile electronic computing device 102 and on client computer 106. The digital dashboard on mobile electronic computing device 102 (digital dashboard 104) displays routes and status information for each driver. The digital dashboard module on client computer 106 (digital dashboard 108) displays the routes and status information to employees of the business. The employees can determine whether the drivers have procured the products, the price paid for each procured product, the time taken to travel to the local vendor and the route taken to the local vendor. The digital dashboard is discussed in more detail later herein with regard to FIGS. 3, 4 and 5.

The example audit module 208 receives status information for each driver regarding the procurement of the identified products. In some implementations, the example audit module 208 receives the status information directly from mobile electronic computing device 102. In other implementations, the audit module 208 receives the status information from dashboard module 206. The status information for each driver can comprise whether the product was procured, a purchase price for the product if the product was procured, the local vendor at which the product was procured, the route taken by the driver to the local vendor, the time taken to reach each local vendor and the total time taken to procure the purchased products. Other status information is possible.

The audit module 208 can compare the status information for each driver with a baseline to determine how the driver performed and whether there were any cost savings. For example, the audit module 208 can compare an actual route taken by the driver to the local vendors with the optimized travel route that was provided to the drivers. When a determination is made that the driver used a different route that the one specified by the routing module 204, the audit module 208 can determine any additional time the driver took over an average time for the optimized travel route. The audit module 208 can also identify an expected price that was supposed to be paid for a product and compare the expected price to a price that the driver actually paid. The audit module 208 can thereby determine whether there were any cost savings regarding the purchases made by the driver. The audit module 208 can also determine whether the driver made stops at any locations not specified by the optimized travel route. Any unnecessary stops could be an indication of unacceptable behavior by the driver. Other audit information is possible.

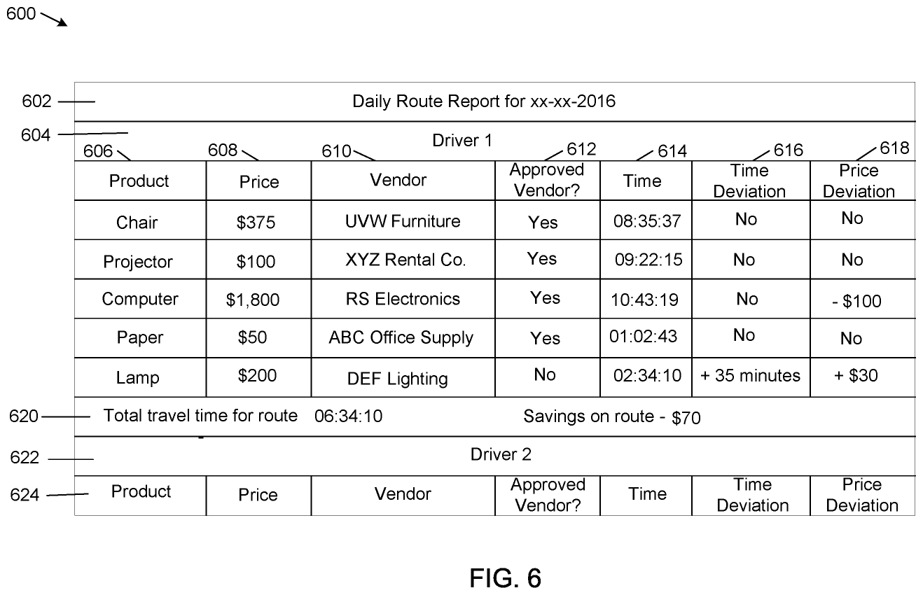

The example reports module 210 generates one or more reports for the business that summarize results of product procurement. As discussed in more detail later herein with regard to FIG. 6, the one or more reports can provide information regarding the products procured by each driver, the prices paid for the products, the vendors at which the products were purchased, the time taken to procure the products, the routes taken, and any cost savings and efficiencies that may have resulted. Other report information is possible.

FIG. 3 shows an example digital dashboard 104. The digital dashboard 104 is rendered on a display screen of the user's smart phone, using a software application on the user's smart phone. The digital dashboard 104 includes software components such as an edit box for a date 302, and a list box for drivers 304 and buttons for a travel route map 306 and for a status summary 308. More, fewer or other software components are possible.

The date 302 edit box permits the user to enter a date for which to view a travel route map 306 of an optimized delivery route or a status summary 308 for the optimized delivery route. The drivers 304 list box lists one or more drivers for which optimized travel routes are available for the date that was entered into date 302 edit box. The user can highlight a specific driver by clicking on the driver's name in the drivers 304 list box. When more drivers are available than can be displayed on the screen of the smart phone, a scroll bar (not shown) can be displayed to permit the user to scroll for additional driver names. In some implementations, a list box can be used instead of the date 302 edit box and the user can select a date rather than enter a date. In some implementations, the drivers 304 list box can be a pull-down list box or an edit list box.

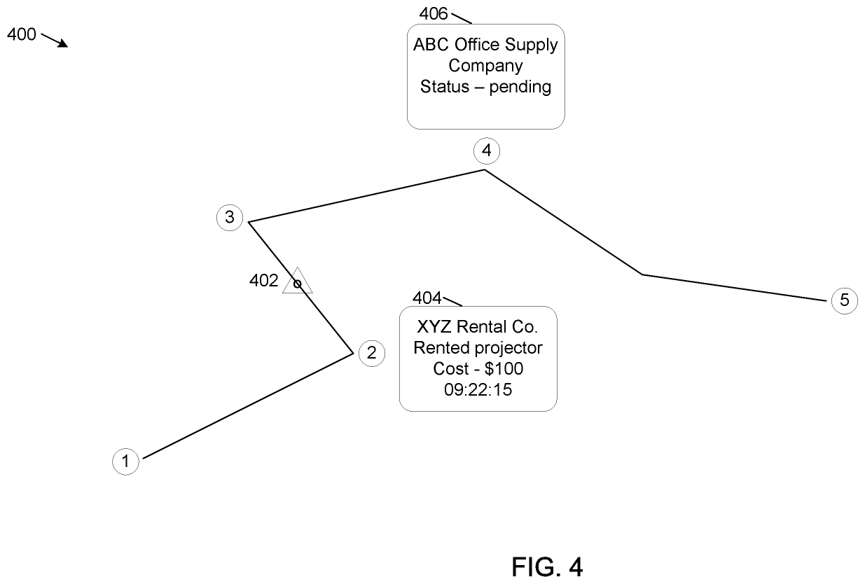

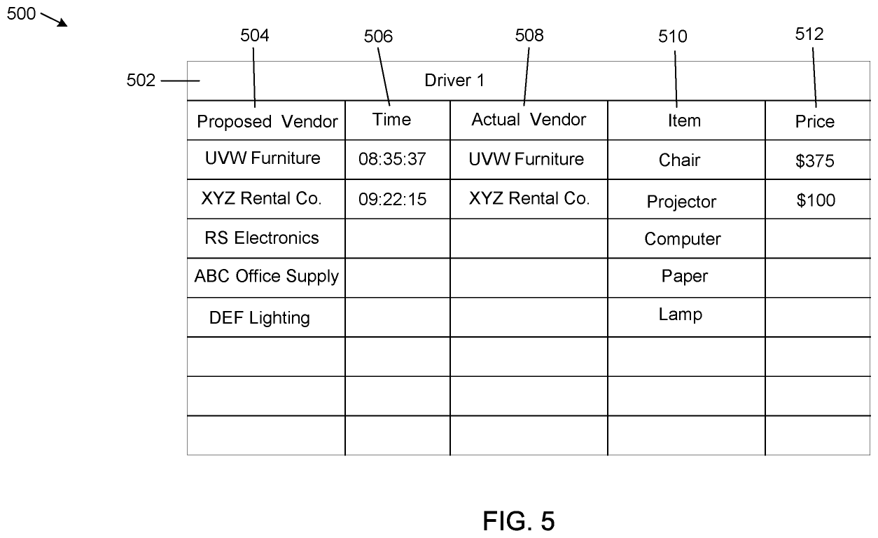

When the travel route map 306 is selected, an optimized travel route is displayed for the highlighted driver on the entered date. A display of the optimized travel route is discussed later herein with regard to FIG. 4. When the status summary 308 is selected, a status summary display of results of using the optimized travel route is displayed on the smart phone. The status summary 308 display is discussed later herein with regard to FIG. 5.

FIG. 4 shows an example optimized travel route 400. The example optimized travel route is displayed on the smart phone when the travel route map 306 button is selected. The example optimized travel route 400 shows five circled vendor locations, numbered 1 to 5. A line between vendor locations represents optimized travel routes for the driver. A current location 402 of the driver is shown as being as being between vendor 1 and vendor 2. In addition, a status window can be displayed at each location by selecting or touching the vendor location. For example status window 404 at location 2 shows that the vendor at location 2 is XYZ Rental Co. and that a projector was rented at the XYZ rental location at a cost of $100. Also, shown is a time stamp (09:22:15) of when the purchase was made. Also shown is an example status window 406 at location 4. The status window 406 shows that a vendor at location 4 is the ABC Office Supply Company. The status is shown as pending and there is no time stamp, indicating that the driver has not yet arrived at vendor location 4. Other information can be included in the status windows.

FIG. 5 shows an example status summary display 500. The example status summary display 500 is displayed on the smart phone when the status summary 308 is selected. The status summary display 500 is for the driver 304 selected in FIG. 3 on a date indicated by date 302. The example status summary display 500 includes status fields for a route being run by the driver 502. The example status fields include a proposed vendor 504, a time 506 at which a purchase was made, an actual vendor 508, a name of an item 510 that was purchased and a price 512 paid for the item.

The example proposed vendor 504 corresponds to the vendor indicated as a desired vendor on the optimized travel route for the driver. For example, referring to FIG. 4, the proposed vendor at location 2 is XYZ Rental Co. and the proposed vendor at location 4 is ABC Office Supply Company. As shown in FIG. 5, additional proposed vendors include RS Electronics, ABC Office Supply and DEF Lighting.

The example time 506 corresponds to a time of an actual purchase of an item. FIG. 5 only shows two time stamps, indicating that at the time at which the status summary display 500 is displayed only two items have been purchased. Time stamps for RS Electronics, ABC Office Supply and DEF Lighting do not have a time stamp, indicating that the driver has not yet reached these locations.

The example actual vendor 508 corresponds to a retail store at which the product was actually purchased. When the driver maintains the proposed optimized travel route and when the retail store on the proposed optimized travel route has the product to be purchased, the driver purchases the product at the retail store. In this case, the actual vendor 508 is the same as the proposed vendor 504. However, for a case where the driver does not follow the optimum route and uses another vendor to purchase the product or when the driver attempts to purchase the product at the retail store but the retail store does not have the product in stock, the actual vendor 508 can be different from the proposed vendor 504.

The example item 510 is an item that the driver is directed to purchase or rent at a corresponding proposed vendor. As shown in FIG. 5, items to be purchased or rented include a chair, a projector, a computer, printing paper and a lamp.

The example price 512 is a price for which the item 510 was purchased or rented. As shown in FIG. 5, the price for purchasing the chair is $375 and the price for renting the projector is $100. The driver has not yet arrived at vendor locations for the computer, paper and lamp, so there are no prices listed for these items.

FIG. 6 shows an example daily route report 600. The daily route report 600 is a daily report that summarizes activity for drivers provided with optimized travel routes on a particular day. More, fewer, or different columns of daily route report 600 are possible. Other reports, for example weekly, monthly and annual reports are possible.

The example daily route report 600 includes sections for each driver of the optimized travel routes on the particular day. A heading 602 shows the date on which the activity occurred. A section 604 for driver 1 is followed by a section 622 for driver 2. Only one row of section 622 is shown. Each section includes columns for product 606, price 608, vendor 610, approved vendor? 612, time 614, time deviation 614 and price deviation 618. In addition, at the end of each section there is a summary line (as shown on row 620) for total travel time for the route and savings on the route.

For driver 1, the product column 606 lists products of chair, projector, computer, paper and lamp. The price column 608 shows that the chair was purchased for $375, the projector was rented for $100, the computer was purchased for $1,800, the printing paper was purchased for $50 and the lamp was purchased for $200.

For driver 1, the vendor column 610 lists the retail store at which the items in the product 606 column were purchased. The approved vendor? 612 column indicates by a yes or a no whether the retail store was an approved vendor. As shown in the approved vendor? column 612, all listed vendors were approved vendors with the exception of DEF lighting. Generally, when the driver uses the optimized travel route, the retail store at which an item is purchased or rented is an approved vendor. When the driver purchases or rents an item from a retail store other than an approved vendor, the driver generally needs to deviate from the optimized travel route. An exception is when two or more retail stores having the same item are located near each other, so that no additional driving is necessary.

The time column 614 shows a timestamp for when an item in the product column 606 is purchased or rented.

The time deviation column 616 indicates whether there is any deviation in a projected time to reach the retail store and actual time to reach the retail store. Generally, the time deviation 616 is no when there isn't a deviation from the optimized travel route and yes when there is a deviation from the optimized travel route. As shown in FIG. 6, because DEF lighting is not an approved vendor, driver 1 needed to deviate from the optimized travel route in order to reach the DEF lighting retail store. Additional time over a time estimated for the optimized travel route is 35 minutes.

The price deviation column 618 indicates whether there is any price deviation between an expected price for the product at the retail store and the price which was paid by the driver. Generally, when the optimized travel route is created, a selection of a vendor to purchase a product is based on a quoted or expected price for the product. When the driver stays on the optimized travel route and purchases or rents the product at a proposed vendor, there is generally no deviation between the price the driver pays and the expected price. However, when the driver purchases or rents the product from a different vendor, the price the driver pays can be different from the expected price. As shown in the price deviation column 618, the driver paid $30 more than expected for the lamp. In this case, the reason was that the driver purchased the lamp at a different retail store than proposed and paid a higher price. In this example, the driver used a different retail store because the proposed retail store did not have the lamp in stock. Also, the driver received a discount on the computer and paid $100 less than expected.

Row 620 of the daily report for driver 1 shows a summary of the travel route taken by driver 1. As shown, the total travel time for the route (including breaks) is 6 hours, 34 minutes and 10 seconds. When the total travel time for the route exceeds a threshold, a determination of non-compliance with the optimized travel route can be made. In an example implementation, a threshold can be a percentage of an expected travel time. For example, a determination of non-compliance can be made when the total travel time exceeds the expected travel time by 10 percent. Other percentages can be used. Other types of thresholds, for example a fixed number of minutes, can be used.

Row 620 also shows that a total of $70 was saved during the route. The driver paid $100 less than expected for the computer, but paid $30 more for the lamp. In some implementations, the savings on the route can be based on a comparison between what was actually paid for an item compared to an average expected cost for the item. The average expected cost for the item can be obtained from an industry average cost for the item. In this case saving can occur when a vendor location on the optimized travel route sells or rents the item for less than the industry average. In general, the optimized travel route attempts to use vendors that provide a good price for an item and that sell or rent the item for less than an industry average.

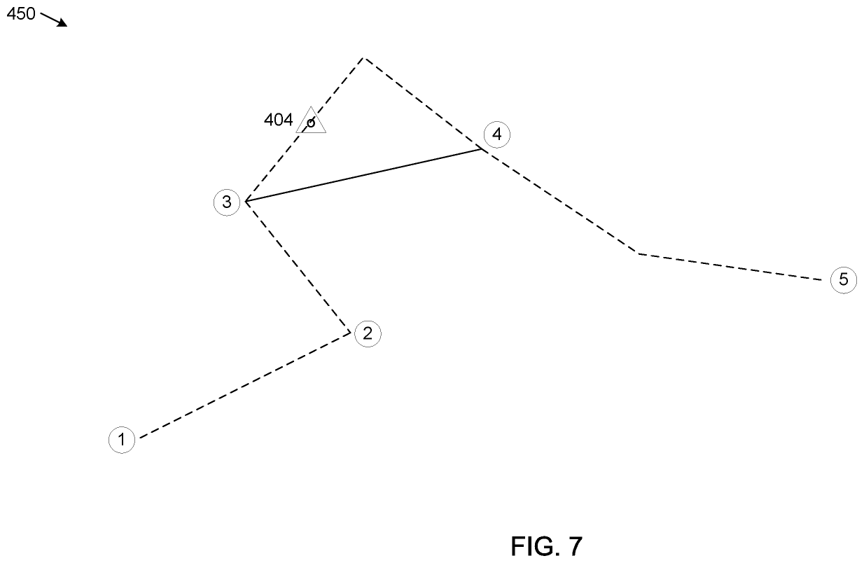

When a determination is made that a driver has deviated from the optimized travel route, an updated optimized travel route can be displayed on the smart phone. In some implementations, the updated optimized travel route can be superimposed on an original optimized travel route. FIG. 7 shows an example of an updated optimized travel route 450 that is superimposed on the original optimized travel route of FIG. 4. The superimposed optimized travel route is shown using dashed lines. Status window 404 shows a current vehicle location.

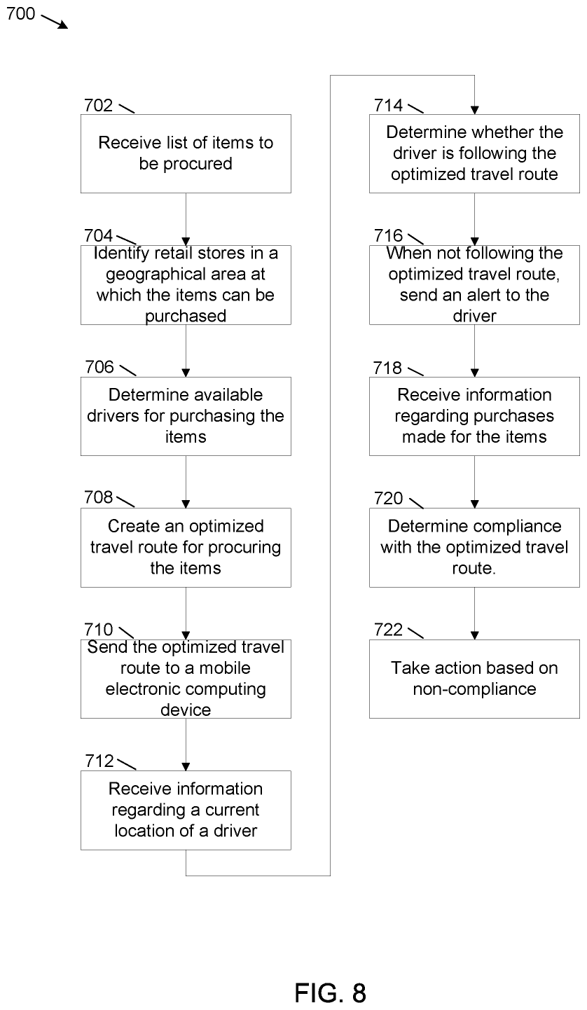

FIG. 8 shows a flowchart of an example method 700 for creating an optimized travel route for procuring business items in a local geographical area and for auditing a performance of vehicle drivers who procure the business items using the optimized travel route. The business drivers are assumed to have a mobile electronic device, such as a smart phone, to be used when procuring the business items according to the optimized travel route.

At operation 702, a list of business items to be procured is received at a server computer. The list can be created by one or more employees of a business. The items to be procured comprise products such as office supplies, office furniture, audio/visual equipment, computers and other business items that are needed by the business. The list can include suggested retail stores in the local geographical area where the business items can be purchased. The list can also include an expected price for the business items. As used in this disclosure, procuring can comprise purchasing or renting the business items.

At operation 704, identification is made of retail stores in the geographical area at which the business items can be purchased. In an example implementation, the one or more employees of the business can select the retail stores based on those that can sell the business items at a good price, for example at a low price compared with other retail stores in the geographical area.

At operation 706, a determination is made as to drivers that are available for procuring the business items. The drivers can be employees of the business or employees of a delivery and pick up service that is separate from the business.

At operation 708, an optimized travel route is created for procuring the business items. The optimized travel route is created by an algorithm that determines cost effective and efficient travel routes based on the number of drivers that are available and the location of the retail stores suggested at which to procure the business items based on a low price and good quality for the business items. Each optimized travel route attempts to minimize driving time and driving distance to reach the retail stores with a goal of minimizing a total traveling time for the plurality of drivers. The optimized travel routes attempt to take into account normal traffic considerations and normal breaks for the drivers, such as a lunch break. When two or more retail stores have a lowest price for a business item, the algorithm can select a retail store for which travel time is minimized.

At operation 710, the optimized travel route for each driver is sent to the mobile electronic computing device. As discussed earlier herein, the mobile electronic computing device displays the optimized travel route on a digital dashboard on the mobile electronic computing device.

At operation 712, information is received at the server computer regarding a current location of a driver. The location information is sent to the server computer periodically, for example every 5 minutes, by the mobile electronic computing device. The location information can be obtained using GPS functionality on the mobile electronic computing device.

At operation 714, a determination is made as to whether the driver is following the optimized travel route. The server computer can make this determination by comparing the current location of the driver to where the driver should be based on the optimized travel route.

At operation 714, when a determination is made that the driver is not following the optimized travel route, at operation 716, the server computer sends an alert to the mobile electronic computing device. The alert can be displayed on a display screen of the mobile electronic computing device. The alert can inform the driver that the driver is not following the optimized travel route.

At operation 718, information is received regarding purchases made for the items. The information is obtained via a message to the server computer from the mobile electronic computing device. The information can include an identifier and location for the retail store at which the purchase was made, the price paid by the driver and a timestamp of when the purchase was made. The price can correspond to a purchase price for the item or a price to rent the item.

At operation 720, a determination is made as to whether the purchases are consistent with the optimized travel route. The server computer can make this determination by comparing an actual route taken by the driver with the optimized travel route. A determination of non-compliance can be made when the actual route taken by the driver differs significantly from the optimized travel route. For example, the determination of non-compliance can be made when the driver takes a route that leads to a retail store that is different than a retail store suggested by the optimized travel route or when the driver skips a retail location and fails to purchase a product corresponding to the skipped retail location. In addition, a determination of non-compliance can be made when the driver pays significantly more for a product than a price proposed on the optimized travel route. For example, a determination of non-compliance can be made when the driver purchases a different product at a higher price or a different model of the product at a higher price.

At operation 722, when a determination of non-compliance is made, the server computer takes one or more actions. One example action is to send an alert to the mobile electronic computing device to inform the driver that the driver is not implementing the optimized travel route. Another example action is to send a message to the mobile electronic computing device with a reminder to the driver that the driver has skipped a retail location. A further action is to send a message to the mobile electronic computing device that the driver has purchase an incorrect item or has paid too much for an item. Other actions are possible.

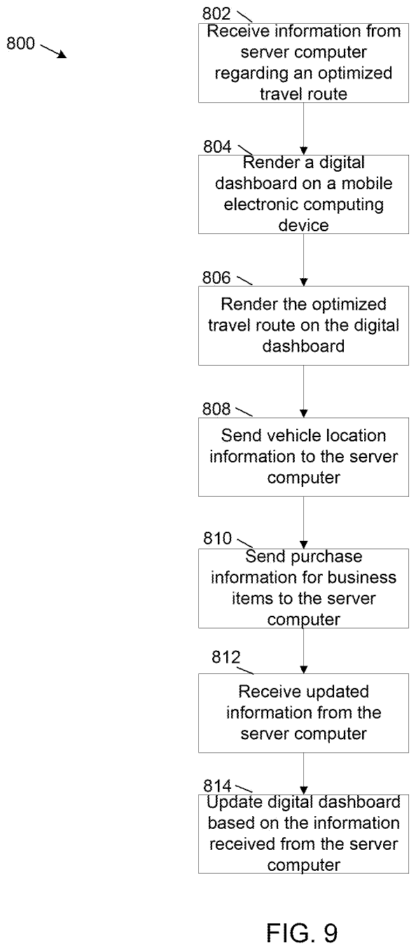

FIG. 9 shows a flowchart of an example method 800 for using a digital dashboard on the mobile electronic computing device.

At operation 802, information is received at the mobile electronic computing device from the server computer regarding an optimized travel route. The information can include a sequence of retail stores at which a driver is procure business items, an identifier, such as a name for each retail store, a location for each retail store, an identification of each product to be procured and a price for which the driver is expected to purchase the product. Other or additional information can be included.

At operation 804, a digital dashboard is rendered on the mobile electronic computing device. For example, a digital dashboard similar to that shown in FIG. 3 can be rendered on a display area of a smart phone.

At operation 806, the optimized travel route is rendered on the digital dashboard. For example, an optimized travel route similar to that shown in FIG. 4 can be rendered on the display area of the smart phone.

At operation 808, the mobile electronic computing device sends a current location of the driver to the server computer. The current location can be obtained using GPS software on the driver's smart phone. The current location can be sent periodically, for example every 5 minutes, although other time intervals can be used.

At operation 810, the mobile electronic computing device sends purchase information for the business items procured to the server computer. The purchase information can include a name of a business item that is purchased or rented, a price paid to procure the business item, a name and a location of a retail store at which the business item was procured and a time stamp indicating a date and time at which the business item was procured.

At operation 812, the mobile electronic computing device updates the digital dashboard based on information received from the server computer. The information can include an updated optimized travel route, updated pricing information, updated product information and one or more alerts or reminders to be displayed to the driver.

At operation 814, the digital dashboard is updated based on the information received from the server computer. For example, the updated optimized travel route can be displayed on the digital dashboard. In some implementations, the updated optimized travel route can be superimposed on the currently displayed optimized travel route. In addition, one or more alert or reminder messages can be displayed on the digital dashboard.

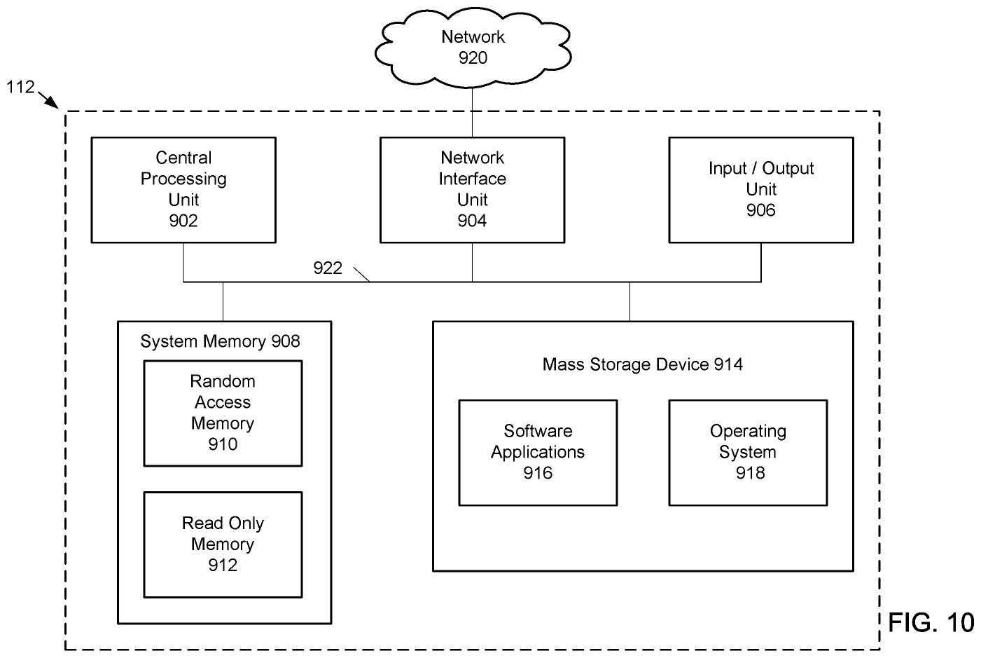

As illustrated in the example of FIG. 10, server computer 112 includes at least one central processing unit (“CPU”) 902, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the server computer 112, such as during startup, is stored in the ROM 912. The server computer 112 further includes a mass storage device 914. The mass storage device 914 is able to store software instructions and data. Some or all of the components of the server computer 112 can also be included in mobile electronic computing device 102 and client computer 106.

The mass storage device 914 is connected to the CPU 902 through a mass storage controller (not shown) connected to the system bus 922. The mass storage device 914 and its associated computer-readable data storage media provide non-volatile, non-transitory storage for the server computer 112. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 112.

According to various embodiments of the invention, the server computer 112 may operate in a networked environment using logical connections to remote network devices through the network 920, such as a wireless network, the Internet, or another type of network. The server computer 112 may connect to the network 920 through a network interface unit 904 connected to the system bus 922. It should be appreciated that the network interface unit 904 may also be utilized to connect to other types of networks and remote computing systems. The server computer 112 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the server computer 112 can store software instructions and data. The software instructions include an operating system 918 suitable for controlling the operation of the server computer 112. The mass storage device 914 and/or the RAM 910 also store software instructions, that when executed by the CPU 902, cause the server computer 112 to provide the functionality of the server computer 112 discussed in this document. For example, the mass storage device 914 and/or the RAM 910 can store software instructions that, when executed by the CPU 902, cause the server computer 112 to display received data on the display screen of the server computer 112.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for auditing implementation of a travel route for procuring items, the method comprising:
on the electronic computing device, receiving a list of items to be procured from a plurality of vendors;
creating an optimized travel route for procuring the items;
displaying a map on a first digital dashboard on the electronic computing device, including markings on the map to indicate the locations of the plurality of vendors and the optimized travel route between the plurality of vendors;
wherein selecting a marking of the markings displays a status window associated with the vendor associated with the marking and wherein the status window includes procurement status and a time stamp of when an item of the items was procured;
sending the optimized travel route to a mobile electronic computing device of a user;
receiving information from the mobile electronic computing device regarding purchases made for the items;
periodically monitoring a location of a vehicle used to procure the items;
displaying the location of the vehicle on the map on the first digital dashboard in near real time;
comparing an actual travel route of the vehicle on the map to the optimized travel route displayed on the map;
using the information received and the location of the vehicle, determining the actual travel route of the vehicle is not in compliance with the optimized travel route;
in response to determining that the actual travel route of the vehicle is not in compliance with the optimized travel route, sending information indicating non-compliance with the optimized travel route to the mobile electronic computing device for display on a second digital dashboard on the mobile electronic computing device;
determining whether items to be procured are procured in an order specified by the optimized travel route;
determining that an item to be procured was skipped; and
in response to determining that an item to be procured was skipped in the optimized travel route, sending a reminder message to the user on the second digital dashboard to purchase the item.

2. The method of claim 1, further comprising:
in response to determining that the travel route of the vehicle is not in compliance with the optimized travel route, sending an alert that the optimized travel route is not being used.

3. (canceled)

4. The method of claim 2, wherein when a determination is made that the user is not using the optimized travel route:
creating an updated optimized travel route; and
sending the updated optimized travel route to the mobile electronic computing device.

5. The method of claim 1, further comprising determining an optimized list of retail stores at which the items can be procured, the optimized list of retail stores including retail stores having a low price for one or more of the items.

6. The method of claim 5, further comprising: for two or more retail stores having a lowest price for an item, identifying a retail store such that travel time to the retail store is minimized.

7. The method of claim 1, wherein determining compliance comprises:
determining whether each item to be procured was procured;
determining whether the optimized travel route was used to procure each item; and
determining whether each item that was procured was procured at a retail store specified by the optimized travel route.

8. The method of claim 1, further comprising:
capturing a purchase history of the items that are procured; and
using the purchase history to create a report summarizing an implementation of the optimized travel route, the report including an indication of whether an item to be procured was procured, a purchase price of each item that was procured and a retail store at which each item was procured.

9. The method of claim 8, wherein the report includes an indication of whether the optimized travel route was implemented and a total time for procuring the items.

10. The method of claim 1, further comprising sending information regarding procurement status to the mobile electronic computing device for display on the second digital dashboard of the mobile electronic computing device, the information including a price of any items purchased.

11. The method of claim 1, wherein using the information received to determine compliance with the optimized travel route comprises:
identifying first retail store locations at which the items were procured;
determining whether the first retail store locations correspond to second retail store locations in the optimized travel route; and
in response to identifying that at least one first retail store does not correspond to a second retail store for procurement of a same item, determine non-compliance with the optimized travel route.

12. The method of claim 11, further comprising:
identifying a total travel time expended to purchase the one or more items;
determining whether the total travel time exceeds a threshold; and
in response to identifying that the total travel time exceeds the threshold, determining non-compliance with the optimized travel route.

13. The method of claim 11, further comprising:
identifying a price at which each item was procured;
obtain an expected price for each item;
for each procured item, compare the price at which the item was procured with the expected price; and
in response to identifying that the price for an item exceeds the expected price, determining non-compliance with the optimized travel route.

14-19. (canceled)

20. An electronic computing device comprising:
a processing unit; and
system memory, the system memory including instructions which, when executed by the processing unit, cause the electronic computing device to:
receive a list of items to be procured;
create an optimized travel route for procuring the items, the optimized travel route including first identifiers for retail stores for procuring each of the items on the list of items and also including first locations of the retail stores;
display a map on a first digital dashboard on the electronic computing device, including markings on the map to indicate the first locations of the retail stores, and the optimized travel route between the retail stores;
wherein selecting a marking of the markings displays a status window associated with the retail store associated with the marking and wherein the status window includes procurement status and a time stamp of when an item of the items was procured;
send the optimized travel route to a mobile electronic computing device;
periodically monitor a location of a vehicle used to procure the items;
receive information regarding purchases for one or more of the items and the location of the vehicle used to procure the items, the information including second identifiers for retail stores at which the purchases for the one or more items were made and second locations of the retail stores at which the purchases were made;
display the second identifiers, second locations and location of the vehicle on the map on the first digital dashboard in near real time;
using the location of the vehicle, determine whether the vehicle is using the optimized travel route to procure the items;
for each item purchased, compare at least one of the first identifiers with at least one of the second identifiers and compare at least one of the first locations with at least one of the second locations; and
when the at least one of the first locations does not match the at least one of the second locations or when a retail store identified by the at least one of the first identifiers does not match a retail store identified by the at least one of the second identifiers:
send a message to the mobile electronic computing device that a user of the mobile electronic computing device is not in compliance with the optimized travel route;
create an updated travel route;
send the updated travel route to a second digital dashboard on the mobile electronic computing device; and
based on the information received regarding the purchases for the one or more of the items:
determine whether each item purchased was purchased in a sequence indicated by the optimized travel route;
determine that an item to be procured was skipped; and
when a determination is made that an item to be procured was skipped in the optimized travel route, send a reminder message to the user on a second digital dashboard to purchase the item.
